(19) United States
(12) Patent Application Publication
(10) Pub. No.: US 2007/0050755 A1
(43) Pub. Date: Mar. 1, 2007

(54) Identification of input sequences

(75) Inventors: Boaz Mizrachi, Haifa (IL); Shmuel Ur, Misgav (IL); Elad Yom-Tov, Haifa (IL)

Correspondence Address: Stephen C. Kaufman;IBM CORPOATION, Intellectual Property Law Dept., P.O. Box 218, Yorktown Heights, NY, 10598, US

(73) Assignee: International Business Machines Corporation, Armonk, NY (US)

(21) Appl. No.: 11/210,922

(22) Filed: Aug. 24, 2005

(51) Int. Cl. G06F 9/44

(52) U.S. Cl. 717/116

(57) ABSTRACT

A method, apparatus and system for identification of input sequences is provided. The method monitors a plurality of commands received by an input device of a computer, analyzes the commands to identify a sequence thereof, and responsive to the identification of the sequence, determines a response action for execution by the computer. The apparatus includes a sequence tracker unit to track a selected sequence for identification from a plurality of commands received by an input device, a logic unit to analyze the selected sequence, a first database of a plurality of identified sequences, each of the identified sequences are coupled to at least one known response action, and a response action determination unit to determine a response action to the selected sequence, if the selected sequence is not coupled to the known response action in the database, or if the selected sequence is couple to a plurality of known response actions.

### FIELD OF THE INVENTION

The present invention relates generally to the field of expert systems in data processing. In particular, the present invention relates to a method and system for identification of input sequences.

### BACKGROUND OF THE INVENTION

Many tasks typically include sequences of inputs or commands that are routinely performed by end users on their computers. For example, such a sequence may be performed when a user starts working and opens her mail program, favorite web-sites, etc. Some software packages, e.g., Microsoft Word® and Matlab®, enable users to record sequences and perform them by using a single command. U.S. Pat. No. 5,448,739 describes a method of recording, playback and re-execution of application program call sequences and import and export of data in a digital computer system. However, typically the user is required to identify the frequently occurring command sequences and define them as a macro. For example, U.S. Pat. No. 6,690,392 describes a method system software and signal for automatic generation of macro commands.

Sequences of inputs or commands may, in some cases, lead to undesired or unlawful actions. These actions should be identified and stopped before they are carried out. A known technique in computer security for preventing undesired or unlawful actions is called intrusion detection. Intrusion detection methods typically monitor the computer environment, including aspects such as the network being monitored, etc., and look for patterns that seem ‘suspicious’. Intrusion detection tools employ a diverse set of techniques. Some use statistical analysis to find whether there is some sequence of inputs or commands that are statistically unexpected, while others check if the performed sequence is known as a harmful or malicious sequence by comparing the sequence to a list of known harmful or malicious sequences which is typically maintained by the provider of the intrusion detection tool. The comparison may be, for example, a string comparison technique. For example, U.S. Pat. No. 5,278,901, assigned to the same assignees of the present invention, describes a pattern-oriented intrusion detection system and method.

M. Nisenson et al., “Towards Behaviometric Security Systems: Learning to Identify a Typist”, Proceedings of the 7th European Conference on Principles and Practice of Knowledge Discovery in Databases (ECML/PKDD), pp. 363-374, 2003, describes utilizing sequences of events for typist identification, by using the temporal sequence of keyboard events.

### SUMMARY OF THE INVENTION

There is provided, in accordance with an embodiment of the present invention, a computer-implemented method for identifying and responding to sequences of commands, including monitoring a plurality of commands received by an input device of a computer, analyzing the commands to identify a sequence thereof, and responsive to the identification of the sequence, determining a response action for execution by the computer.

In one aspect of this embodiment of the present invention, the step of monitoring the plurality of commands further includes applying a randomly selected sequence to analysis.

In another aspect of this embodiment of the present invention, the step of monitoring the plurality of commands further includes selecting a sequence for analysis every predetermined timeframe.

In yet another aspect of this embodiment of the present invention, the step of monitoring the plurality of commands further includes applying the monitored sequence responsive to a sequence particularly tracked is the step of monitoring.

In one aspect of this embodiment of the present invention, the step of analyzing the commands further includes comparing the monitored sequence to a list of identified sequences.

In another aspect of this embodiment of the present invention, the step of comparing the monitored sequence further includes comparing the monitored sequence to a local list of identified sequences which is saved on the station of the user, and if the monitored sequence was not found in the local list of identified sequences, comparing the monitored sequence to a central list of identified sequences which is saved in a central repository. The central list includes the identified sequences of all users connected to the central repository.

In yet another aspect of this embodiment of the present invention, the step of comparing the monitored sequence to the central list includes determining a response action if the monitored sequence was not coupled to the central list of identified sequences, or if a multiplicity of sequences were coupled to the central list of identified sequences.

In accordance with an embodiment of the present invention, the step of determining the response action is done by a human operator.

In accordance with another embodiment of the present invention, the step of determining the response action is done automatically.

In accordance with yet another embodiment of the present invention, the step of determining the response action is done by the user.

There is further provided, in accordance with an embodiment of the present invention an apparatus for identification and response to sequences of commands, including a sequence tracker unit to track a selected sequence for identification from a plurality of commands received by an input device, a logic unit to analyze the selected sequence, a first database of a plurality of identified sequences, each of the identified sequences are coupled to at least one known response action, and a response action determination unit to determine a response action to the selected sequence, if the selected sequence is not coupled to the known response action in the database, or if the selected sequence is couple to a plurality of known response actions.

In one aspect of this embodiment of the present invention, the at least one known response action is tagged to the identified sequence in the first database.

In another aspect of this embodiment of the present invention, the at least one known response action is stored in a second database of a plurality of known response actions.

In accordance with an embodiment of the present invention, the selected sequence is tracked randomly by the sequence tracker.

In accordance with another embodiment of the present invention, the selected sequence is tracked by the sequence tracker every predetermined timeframe.

In accordance with yet another embodiment of the present invention, the selected sequence is selectively tracked by the sequence tracker in response to a particular sequence.

In one aspect of this embodiment of the present invention the logic unit compares the selected sequence to the plurality of identified sequences.

According to an embodiment of the present invention the response action determination unit transfers the selected sequence or the plurality of known response actions for an operator or a user to determine a response action.

There is further provided, in accordance with an embodiment of the present invention a system for identification and response to sequences of commands, including at least one computer station, the station includes a sequence tracker unit to track a selected sequence for identification from a plurality of commands received by an input device. The system further includes a central repository to centrally store a plurality of identified sequences in a database of identified sequences, each of the identified sequences is coupled to a known response action, the central repository includes a logic unit to analyze the selected sequence, and a response action determination unit to determine a response action to the selected sequence, if the selected sequence is not coupled to the known response action in the database, or if the selected sequence is couple to a plurality of known response actions.

In one aspect of this embodiment of the present invention the at least one computer station further includes a local database to store a plurality of identified sequences in a database of identified sequences, each of the identified sequences is coupled to a known response action.

In another aspect of this embodiment of the present invention, the at least one computer station further includes a local logic unit to locally analyze the selected sequence.

In one aspect of this embodiment of the present invention the local logic unit transfers the selected sequence for further analysis by the central repository if no identified sequence was found by the local logic unit.

There is further provided, in accordance with an embodiment of the present invention a computer program product stored on a computer readable storage medium, comprising computer readable program code means for performing the steps of monitoring a plurality of commands received by an input device of a computer, analyzing the commands to identify a sequence thereof, and responsive to the identification of the sequence, determining a response action for execution by the computer.

There is further provided, in accordance with an embodiment of the present invention a method of providing a service to a customer over a network, including monitoring a plurality of commands received by an input device of a computer, analyzing the commands to identify a sequence thereof, and responsive to the identification of the sequence, determining a response action for execution by the computer.

The present invention will be more fully understood from the following detailed description of the embodiments thereof, taken together with the drawings in which:

### BRIEF DESCRIPTION OF THE DRAWINGS

Embodiments of the present invention will now be described, by way of examples only, with reference to the accompanying drawings in which:

FIG. 1 is a block diagram that schematically illustrates a system for automatic identification of sequences, in accordance with an embodiment of the present invention;

FIG. 2 is a flow chart diagram that schematically illustrates a method of automatic identification of sequences, in accordance with an embodiment of the present invention;

FIG. 3 is a flow chart diagram that schematically illustrates a method of automatic identification of installation sequences, in accordance with an embodiment of the present invention; and

FIG. 4 is a flow chart diagram that schematically illustrates a method for automatically identification of malicious or undesired sequences, in accordance with an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DESCRIPTION OF EMBODIMENTS OF THE PRESENT INVENTION

### Overview

In computer systems, it is generally desirable to identify sequences of inputs or commands with minimal human intervention. Such an automatic identification may be useful, for example, to automatically generate a macro for the user, to identify undesired or malicious actions and stop them, and to assist the user in solving problems related, for example, to actions performed by many users, such as installation of new software or access to common data storage areas, etc., as will be described in detail below.

The identification of a sequence of inputs or commands (hereinafter the term “sequence” will be used for simplicity) that is used repeatedly by a group of users, or repeatedly by a specific user, may increase the efficiency and usability of the tasks being performed by the user or the group of users. Furthermore, such identification may also assist in providing solutions to users based on previous solutions provided by other users and previously identified. For example, a system may identify, based on a sequence of commands of a software application, that the software being executed is reaching its memory limit, and it may suggest solutions to the user of the software application. The solution may be one of many solutions that other users found, and that were recorded and saved by the system.

A sequence is defined herein as a chronological chain of inputs or commands, which at each time instance preferably includes a system state, e.g., which relevant programs are currently running, which thread is using the operating resources, etc., and which user input, e.g., keyboard entry, mouse movement, etc., is currently entered. Such sequences may be automatically identified by, for example, tracking user behavior over a certain length of time, as will be described in detail below.

In embodiments of the present invention that are described hereinbelow the chronological chain may be decomposed into sub-chains in order to identify common actions, allowing various algorithms, including but not limited to clustering algorithms, string comparison algorithms, and other machine learning algorithms, to be executed to detect characteristics of the sub-chains. For example, the frequency rate of the occurrence of the sub-chains, or the probable state change, e.g., the most likely action (input entry or command) that may be taken after a certain sub-chain is executed, etc., may be detected. Any such identified sub-chain which occurs, for example, at a frequency above a threshold level, or above a certain likelihood, is a candidate for definition as a response action, for example, a macro. This threshold may be defined by the user or by an external user, such as an administrator of the computer system of the user.

In accordance with embodiments of the present invention undesired or malicious sequences may be prevented or stopped before they are carried out. Undesired or malicious sequences may be defined by a security manager or automatically as will be described in detail below. Security breaches may then be prevented by informing the administrator or reacting according to rules of a security policy, e.g., shutting down a computer, in response to the identification of undesired or malicious sequence. Such a sequence may be the generated by a malicious code, e.g., a computer virus etc., or by the user.

### System Description

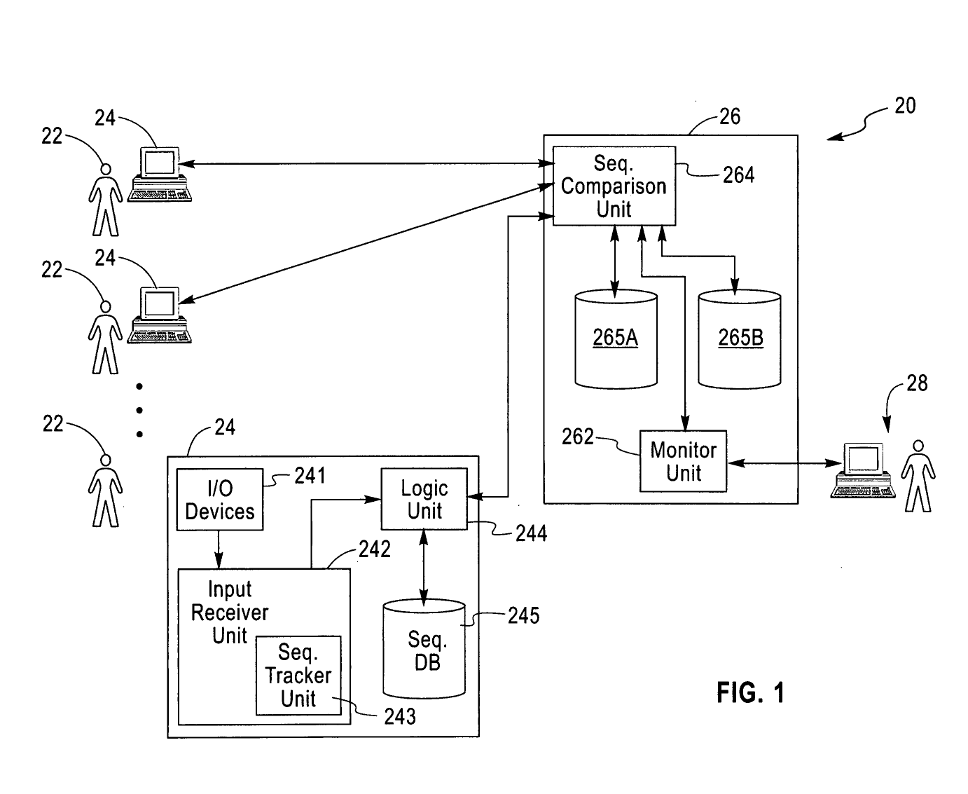

Reference is now made to FIG. 1 which is a block diagram that schematically illustrates a system 20 for automatic identification of sequences, in accordance with an embodiment of the present invention. Stations 24 of users 22 are connected to central repository 26. Stations 24 may communicate with central repository 26 using a temporary or a permanent network connection, such as an Internet connection. Alternatively, stations 24 may connect to central repository 26 using a direct connection such as a leased line or a dial-up connection, or using any other suitable connection means.

Users 22 may work together, and may accordingly all be connected to the same network. Alternatively, users 22 may be using a service for automatic identification of sequences, and as such, they may be connected to the central repository 26. Central repository 26 may be a dedicated server, or a repository in a shared server. It may be integral to the internal network of users 22, or external to it.

A personal station 24 of user 22 may be, for example, a personal computer, a laptop computer, a Personal Digital Assistant (PDA), etc. Station 24 may include I/O devices 241 such as a network adaptor, keyboard, mouse, a display, etc. I/O devices 241 may be connected to an input receiver unit 242. Input receiver unit 242 may receive and centralize the inputs from all I/O devices 241. It may include a sequence tracker unit 243. Alternatively, sequence tracker unit 243 may be a distinct unit in station 24, connected to input receiver unit 242, or it may be embedded in central repository 26.

Sequence tracker unit 243 may track sequences such as, but not limited to, the following sequences:
A combination of actions resulting in reading the address book of user 22 as stored on station 24 and sending similar e-mail messages to many addressees.
Installation sequences resulting in a failure of the installation.
Sequences that are performed on a frequent basis by the user. It should be noted that the frequency level may be configured manually by user 22, by the operator of system 20, or automatically by any of the machine learning algorithms mentioned above.
Communication sequences that begin a malicious operation on other computers.

It should be noted that sequence tracker unit 243 may track sequences that are originated from I/O devices 241, and in addition, it may track sequences of applications executed in station 24.

Station 24 may further include a logic unit 244 to control and process identification of the sequences. Alternatively, logic unit 244 may be embedded in central repository 26. The logic unit 244 may be connected to the input receiver unit 242 and to a database 245 of known sequences or sequences that may be allowed to be performed, and their respective response actions. Logic unit 244 may also be connected to central repository 26 for analysis and comparison of sequences that are not found in database 245.

Central repository 26 may include a sequence comparison unit 264, which may receive the sequences transferred from stations 24 with identified sequences previously transferred from stations 24 and stored in database 265A. The sequences stored in database 265A may be tagged to the respective response action to be performed. Alternatively or additionally, central repository 26 may include a database 265B of response actions that may be matched to a sequence from database 265A. The sequence comparison unit 264 may be connected to databases 265A and 265B, and to a response action determination unit 262. Sequence comparison unit 264 may match sequences from database 265A to response actions 265B. It may then transfer the matched response action to users 22, or, if no match was found, or if multiple matches were found, it may transfer the sequence and the response actions to the response action determination unit 262. In accordance with an alternative embodiment of the present invention, the multiple response actions may be presented to user 22 to determine what response action is the applicable response action.

Response action determination unit 262 may display unidentified sequences to an operator 28 of system 20. Alternatively, it may display sequences with multiple response actions to the operator 28 of the system, to allow the operator to decide which response action should be matched with the identified sequence. It should be noted that response action determination unit 262 may make decisions automatically, as will be described in detail below. After determining what the desired response action is, whether the determination is performed by operator 28 or automatically by response action determination unit 262, or as described above by the user 22, the response action may be distributed to stations 24. Additionally, the response action may be tagged to the respective sequence in database 265A, and/or it may be stored in database 265B, for future use.

### Automatic Identification of Sequences Method Description

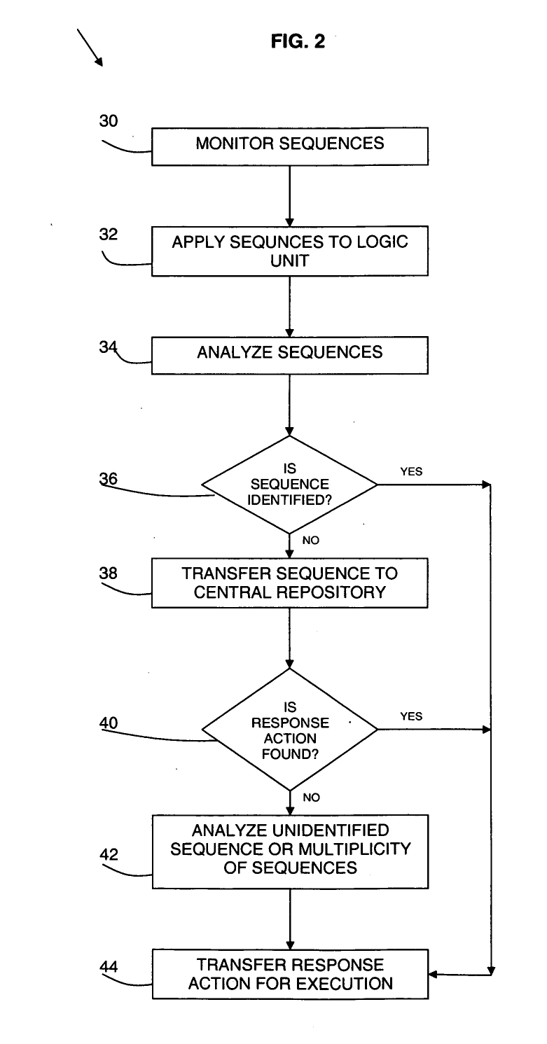

Reference is now made to FIG. 2 which is a flow chart diagram that schematically illustrates a method of automatic identification of sequences, in accordance with an embodiment of the present invention. The method of FIG. 2 may be implemented by the system of FIG. 1. Sequence tracker unit 243 continuously monitors sequences reported by input receiver unit 242, at a monitoring step 30. Sequence tracker unit 243 may apply logic unit 244 to the sequences, at a sequence application step 32. The application step may be performed at random or predetermined intervals, or selectively in response to a particular sequence tracked by the sequence tracker unit 243, or further in response to a trigger action performed by the user. For example, when the purpose of the identification of the sequences is to assist users to install applications, an error in the installation process may be particularly tracked by the sequence tracker unit 243. In another example, when sequences are identified to identify frequent activities of the user, the application step may be performed at random or predetermined intervals. In yet another example, for security purposes, the application step may be performed on a sequence of actions executed at a specific time.

Thereafter, the logic unit 244 and the database 245 may jointly analyze the sequences at a sequence analysis step 34. Logic unit may use a variety of algorithms to identify the sequences as will be described in detail below. If a sequence is not identified and it is not stored in database 245 (step 36), the sequence may be transferred to central repository 26, at a transfer sequence step 38. The sequence may also be transferred from the input receiver unit 242 to the central repository 26 when the tracking of the sequence and the logical operations are performed in central repository 26. The transferred sequences may then be compared to the identified sequences in database 265A at a sequence comparison step 40. If a sequence is not stored in database 265A, or if multiple sequences are found, the sequence or the sequences may be transferred to response action determination unit 262 for analysis by a human operator or for automatic analysis, at an analysis request step 42. If a sequence is found and a response action is tagged to it, or a response action is found in database 265B, the response action is transferred to station 24 for execution, at a response action transfer step 44. If multiple response actions are matched to the analyzed sequence, the response actions are transferred to the response action determination unit 262 for analysis by a human operator, at the analysis request step 42 mentioned above. According to the analysis performed by the human operator, a response action is transferred to station 24 for execution, at the response action transfer step 44 mentioned above. In accordance with an alternative embodiment of the present invention, the multiple response actions may be presented to user 22, to determine and execute what response action is the applicable response action, at a determination and execution step (not shown).

In addition to the method of automatic identification of sequences, the identified sequences and the respective response actions are stored in databases 245 of stations 24, and/or in databases 265A and 265B. New identified sequences are transferred to databases 245 for update. Response action determination unit 262 may control the updating process. Updates may be sent periodically, such as on a weekly basis or any other frequency, as defined by the users or by the operator of system 20. Important updates, e.g., response actions to sequences performing crucial security violations or breaches, response actions to software installation sequences, etc., may be sent to users upon identifying them and storing them at databases 265A and 265B.

### Analysis of the Sequences

Logic unit 244 (whether it is located in station 24 or in central repository 26) may implement any of several possible methods to analyze the sequences. As will be described below, similar methods may be used by response action determination unit 262 to determine which response action is to be performed in response to an unidentified sequence, or which response action is to be performed from one or more applicable response actions.

Firstly, one method is to ask the users for feedback about the sequences that led their software application or station to the current position.

Secondly, logic unit 244 may analyze sequences in two steps. First, it may measure the distance between sequences, e.g., the level of similarity between sequences, and second, it may perform the actual analysis.

Distance measurement may be done using measurement methods such as string comparison methods. Examples of such methods are edit distance, i.e., what is the minimum number of operations needed to transform one string into the other, or Boyer-Moore string matching, i.e., preprocessing the target response action that is being searched for, but not the sequence being searched, as described, for example, by Richard O. Duda et al. in Wiley, “Pattern Classification”, 2nd ed, 2001, page 416. Other distance measurements that may be used include Hamming distance measurements, or probability estimates using, for example, Markov sequences.

After the distance between two sequences is measured, logic unit 244 may perform the actual analysis of the sequence.

When databases 245 or 265A include tagged sequences (i.e., previously identified), a new sequence may be tagged using machine learning methods such as support-vector machines (SVM), as described, for example, by Richard O. Duda et al. in “Pattern Classification”, page 259, mentioned above. Another applicable tagging method employs nearest neighbor classification, in which the tagging given to the new sequence may be determined by a majority vote between the k nearest neighbors to the sequence being tagged, where k is an integer determined during training of the classifier. A more detailed description of this classification method may be found, for example, in the “Pattern Classification” reference mentioned above at page 182.

When the sequences are not tagged, they may be clustered together into similar sequences using k-means, agglomerative clustering, etc, as described, for example, in the “Pattern Classification” reference mentioned above, at pages 527 and 552, respectively.

A mirror operation may be performed by response action determination unit 262 to determine which response action is to be performed in response to an unidentified sequence, or which response action is to be performed from any of several applicable response actions. When the sequence is not identified, clustering algorithms may be executed to determine whether the unidentified sequence belongs to a known cluster, and as such, one or more response actions may be applicable to it. When any of several response actions may be applicable, machine learning algorithms may be executed to determine which response action is the most applicable. It should be noted that response action determination unit 262 may transfer the unidentified sequence or any of the applicable response actions to the operator 28 for human analysis.

### Exemplary Implementation—Improving Usability

The following section describes an exemplary method for improving the usability of a software application, demonstrating the automatic sequence identification methods and systems disclosed herein. In the present example, system 20 (FIG. 1) belongs to an administration and support division of an organization, and users 22 are end-users of the organization. Users 22 may be required to perform end-point operations, such as but not limited to installation of new software applications on their stations 24, changing the definitions or configurations of the applications they work on, etc.

In a typical scenario, users 22 may receive a message with a link to a new software package, saved in a central place, to be installed on their station with instructions how to perform the installation. Some users may not follow the exact instructions, and therefore the installation process will fail. In other cases, even though user 24 follows the installation process correctly, it may fail due to conflicts with other software applications installed on his station. Such a conflict may be a result of competing resources, compatibility issues, etc. The installation may fail due to many other reasons, such as, but not limited to, connection failure to the location where the software package is found.

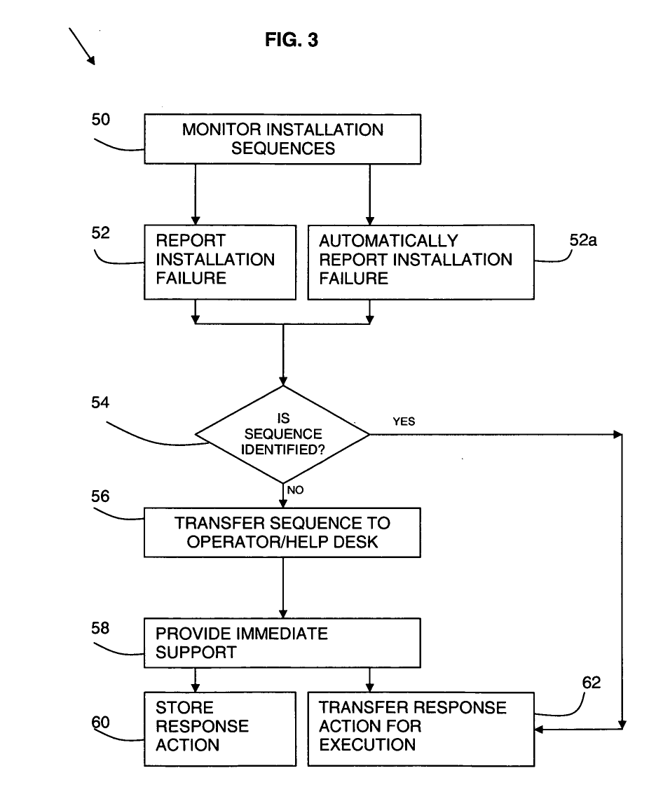

Reference is now made to FIG. 3 which is a flow chart diagram that schematically illustrates a method of automatic identification of installation sequences, in accordance with an embodiment of the present invention. As described above, a sequence tracker unit continuously monitors for installation sequences reported by the input receiver unit of the station of each user, at an installation monitoring step 50. In case the installation fails, the user may report the failure manually, for example, by clicking a UI button, or in any other way, in a reporting failure step 52. Alternatively, a preliminary analysis of the sequences may be performed and an automatic failure report may be generated, at an automatic failure report 52A. This report may include, for example a list of the sequences leading to the failure, as well as pertinent information such as link description, replica, author, target, server name, etc.

If the reported sequence is already identified (step 54) locally on the user's station or in a central repository of all identified sequences, a response action may be automatically or manually transferred to the user, at a transferring known response action step 62. A manual transfer of the known response action may be performed by an operator of the administration and support division of the organization, or by an operator of a helpdesk call center.

Alternatively, if the reported the sequence is not identified, it may be transferred to an administrator in the administration and support division of the organization, or to an operator of a helpdesk call center, at a transfer sequence step 56. The operator may contact the user that performed the new sequence for immediate support, at an immediate supporting step 58, and may transfer the response action, at transfer known response action step 62. In addition, the operator may store the solution for future use in response to the sequence which has been identified, at a storing response action step 60.

### Exemplary Implementation—Identification of Security Violations

The following section describes an exemplary method for identifying security violation, demonstrating the automatic sequence identification methods and systems disclosed herein. In the present example, and similarly to the example above, system 20 belongs to an administration and support division of an organization, and users 22 are end-users of the organization. Users 22 may be required to comply with the security policy of the organization. As such, they may be prohibited from performing certain actions, such as, for example, downloading material from web sites that are not permitted according to the security policy, sending e-mails with confidential information, etc. In addition, the organization wishes to protect its computer systems from infection by malicious code.

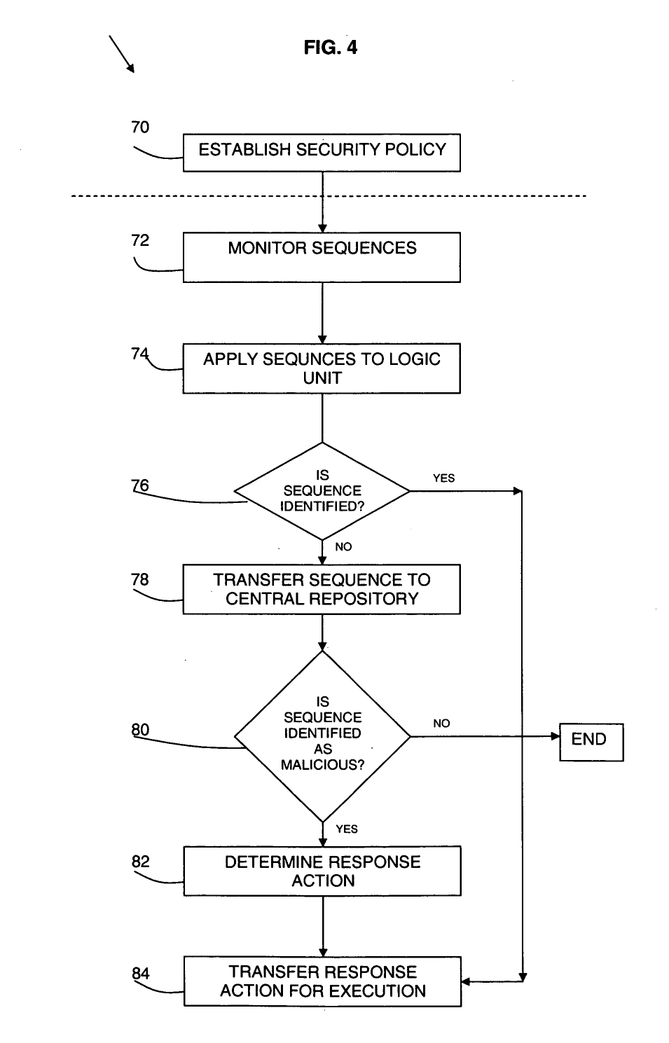

FIG. 4 is a flow chart diagram that schematically illustrates a method for automatically identification of malicious or undesired sequences, in accordance with an embodiment of the present invention. A security policy may be established, and undesired or malicious sequences may be defined by a security manager or automatically as was described in detail above, at a preliminary security policy establishment step 70. A sequence tracker unit continuously monitors sequences reported by input receiver unit 242, at a monitoring step 72. When a potentially suspicious sequence is identified at the monitoring step, the sequence may be applied to the logic unit, at a sequence application step 74. The logic unit may analyze the sequence and compare it to a list of identified malicious sequences at a sequence analysis step 76.

If the sequence is previously identified, locally on the user's station, or in a central repository of all identified sequences, a response action may be automatically or manually transferred to the user, at a transferring known response action step 84. The response action may be, for example, shutting down the station, or closing the software application that generated the malicious sequence.

If the sequence is not identified, the sequence may be transferred to a central repository of the organization, at a transfer sequence step 78, for further examination in the central repository. The examination may be done by the security manager, or, for example, automatically by quarantining and examining software in an isolated environment.

If the sequence is then identified as a malicious sequence (step 80), a response action may be determined, at a determining response action step 82, and the response action is applied to the station that generated the malicious sequence, at the transferring known response action step 84 mentioned above. In addition, the response action may be stored for future use in response to the sequence which is now already identified (not shown).

In the description above, numerous specific details were set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code that embodies aspects of the present invention is typically maintained in permanent storage, such as a computer readable medium. In a client-server environment, such software programming code may be stored on a client or server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications network, such as the Internet. In addition, while the invention may be embodied in computer software, the functions necessary to implement the invention may alternatively be embodied in part or in whole using hardware components such as application-specific integrated circuits or other hardware, or some combination of hardware components and software.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the forgoing description.

1. A computer-implemented method for identifying and responding to sequences of commands, comprising:
monitoring a plurality of commands received by an input device of a computer;
analyzing said commands to identify a sequence thereof; and
responsive to the identification of said sequence, determining a response action for execution by said computer.

2. The method according to claim 1, wherein said monitoring said plurality of commands further comprises applying a randomly selected sequence to analysis.

3. The method according to claim 1, wherein said monitoring said plurality of commands further comprises selecting a sequence for analysis every predetermined timeframe.

4. The method according to claim 1, wherein said monitoring said plurality of commands further comprises applying said monitored sequence responsive to a sequence particularly tracked in said step of monitoring.

5. The method according to claim 1, wherein said analyzing said commands further comprises comparing said monitored sequence to a list of identified sequences.

6. The method according to claim 5, wherein said comparing said monitored sequence further comprises:
comparing said monitored sequence to a local list of identified sequences which is saved on said station of said user; and
if said monitored sequence was not found in said local list of identified sequences, comparing said monitored sequence to a central list of identified sequences which is saved in a central repository, said central list includes the identified sequences of all users connected to said central repository.

7. The method according to claim 6, wherein said comparing said monitored sequence to said central list comprises determining a response action if said monitored sequence was not coupled to said central list of identified sequences, or if a multiplicity of sequences were coupled to said central list of identified sequences.

8. The method according to claim 7, wherein said determining said response action is done by a human operator.

9. The method according to claim 7, wherein said determining said response action is done automatically.

10. The method according to claim 7, wherein said determining said response action is done by said user.

11. Apparatus for identification and response to sequences of commands, comprising:
a sequence tracker unit to track a selected sequence for identification from a plurality of commands received by an input device;
a logic unit to analyze said selected sequence;
a first database of a plurality of identified sequences, each of said identified sequences are coupled to at least one known response action; and
a response action determination unit to determine a response action to said selected sequence, if said selected sequence is not coupled to said known response action in said database, or if said selected sequence is couple to a plurality of known response actions.

12. The apparatus according to claim 11, wherein said at least one known response action is tagged to said identified sequence in said first database.

13. The apparatus according to claim 11, wherein said at least one known response action is stored in a second database of a plurality of known response actions.

14. The apparatus according to claim 11, wherein said selected sequence is tracked randomly by said sequence tracker.

15. The apparatus according to claim 11, wherein said selected sequence is tracked by said sequence tracker every predetermined timeframe.

16. The apparatus according to claim 11, wherein said selected sequence is selectively tracked by said sequence tracker in response to a particular sequence.

17. The apparatus according to claim 11, wherein said logic unit compares said selected sequence to said plurality of identified sequences.

18. The apparatus according to claim 11, wherein said response action determination unit transfers said selected sequence or said plurality of known response actions for an operator or a user to determine a response action.

19. A system for identification and response to sequences of commands, comprising:
at least one computer station, said station comprises a sequence tracker unit to track a selected sequence for identification from a plurality of commands received by an input device;
a central repository to centrally store a plurality of identified sequences in a database of identified sequences, each of said identified sequences is coupled to a known response action, said central repository comprising:
a logic unit to analyze said selected sequence; and
a response action determination unit to determine a response action to said selected sequence, if said selected sequence is not coupled to said known response action in said database, or if said selected sequence is couple to a plurality of known response actions.

20. The system according to claim 19, wherein said at least one computer station further comprises a local database to store a plurality of identified sequences in a database of identified sequences, each of said identified sequences is coupled to a known response action.

21. The system of claim 19, wherein said at least one computer station further comprises a local logic unit to locally analyze said selected sequence.

22. The system of claim 19, wherein said local logic unit transfers said selected sequence for further analysis by said central repository if no identified sequence was found by said local logic unit.

23. A computer program product stored on a computer readable storage medium, comprising computer readable program code means for performing the steps of:
monitoring a plurality of commands received by an input device of a computer;
analyzing said commands to identify a sequence thereof; and
responsive to the identification of said sequence, determining a response action for execution by said computer.

24. The method according to claim 23, wherein said monitoring said plurality of commands further comprises applying a randomly selected sequence to analysis.

25. The method according to claim 23, wherein said monitoring said plurality of commands further comprises selecting a sequence for analysis every predetermined timeframe.

26. The method according to claim 23, wherein said monitoring said plurality of commands further comprises applying said monitored sequence responsive to a sequence particularly tracked is said step of monitoring.

27. The method according to claim 23, wherein said analyzing said commands further comprises comparing said monitored sequence to a list of identified sequences.

28. The method according to claim 27, wherein said comparing said monitored sequence further comprises:
comparing said monitored sequence to a local list of identified sequences which is saved on said station of said user; and
if said monitored sequence was not found in said local list of identified sequences, comparing said monitored sequence to a central list of identified sequences which is saved in a central repository, said central list includes the identified sequences of all users connected to said central repository.

29. The method according to claim 28, wherein said comparing said monitored sequence to said central list comprises determining a response action if said monitored sequence was not coupled to said central list of identified sequences, or if a multiplicity of sequences were coupled to said central list of identified sequences.

30. The method according to claim 29, wherein said determining said response action is done by an operator or by said user.

31. The method according to claim 29, wherein said determining said response action is done automatically.

32. A method of providing a service to a customer over a network, the service comprising:
monitoring a plurality of commands received by an input device of a computer;
analyzing said commands to identify a sequence thereof; and
responsive to the identification of said sequence, determining a response action for execution by said computer.

33. The method according to claim 32, wherein said analyzing said commands further comprises comparing said monitored sequence to a list of identified sequences.

34. The method according to claim 33, wherein said comparing said monitored sequence further comprises:
comparing said monitored sequence to a local list of identified sequences which is saved on said station of said user; and
if said monitored sequence was not found in said local list of identified sequences, comparing said monitored sequence to a central list of identified sequences which is saved in a central repository, said central list includes the identified sequences of all users connected to said central repository.

35. The method according to claim 34, wherein said comparing said monitored sequence to said central list comprises determining a response action if said monitored sequence was not coupled to said central list of identified sequences, or if a multiplicity of sequences were coupled to said central list of identified sequences.
